(19) United States
(12) Patent Application Publication
(10) Pub. No.: US 2009/0144137 A1
(43) Pub. Date: Jun. 4, 2009

(54) AUTOMATED CONTENT PRODUCTION FOR LARGELY CONTINUOUS TRANSMISSION

(76) Inventors: Gregory Hagan Moulton, (US); David Charles Cartt, (US)

Correspondence Address: GREGORY HAGAN MOULTON, 6 BAYBERRY WAY, IRVINE, CA, 92612, US

(21) Appl. No.: 11/309,295

(22) Filed: Jul. 21, 2006

(51) Int. Cl. G06Q 30/00

(52) U.S. Cl. 705/14; 705/26

(57) ABSTRACT

An efficient, highly automated system and method of producing audio visual content which depicts a solely simulated 3D environment, or combined simulated and real 3D environment with advantages over conventional content production paradigms. The present invention produces content with the following significant advantages over conventional means of content production: vastly longer continuous durations of generated output; far lower resource costs per hour of production; far more reliable generation of content; and a far broader range of content styles due to the combination of these advantages.

The present invention relates, in general, to the automated generation of audio visual content using computational engines and 3D software rendering systems for presentation over broadcast networks or other content distribution systems.

The invention described herein is a video content generation system and mechanism capable of producing content in a highly automated way, from specification to generation. An advantage of this invention is the reduction in manual labor required for content creation. This is a digital assembly line with powerful advantages over conventional content creation methodologies: reduced cost, reduced time and increased volume. This approach allows producing content with novel characteristics, changing the role of active media in the lives of people everywhere. It is a new means of doing business in the production of content for a fee. It offers content distributors new markets, increasing the size of their subscriber base. Its mechanism is uniquely suited to producing content appropriate for business environments. The technology can produce both novel forms of content and conventional ones. Its cost savings and speed allow the delivery of production content for a price so low that it can produce unique content for a single viewing for a single viewer.

The invention described herein is a digital computational content generation engine designed to efficiently produce video at rates far in excess of conventional methods of production. Furthermore, this method of production allows superior content fidelity to be transmitted with reduced information. It allows a resolution independent transmission to provide custom configurations of uniform or non-uniform display shapes and resolutions with content that optimizes their characteristics.

### RELEVANT BACKGROUND

Economic, political and social networks are increasingly affected by the projection of media presentations. Wealth and power are routinely influenced by the quality, prevalence, and persuasion of these projections. Traditionally the production of media content for presentation is a manpower intensive operation. Theatrical presentations, and filmed and televised productions generally involve many people, working thousands of hours—script writers and editors, location scouts, casting agents, financial backers, executive directors, producers, cast, crew, and a multitude of auxiliary personal are routinely involve in this process. Additional substantial manpower is also used in the distribution process. Conventional methods of producing content therefore suffer from labor intensive operation, high costs and production reliability problems. The degree of the labor involved is reflected in the total cost of production for mainstream movies, which in the United States of America in 2005 was approximately $40 million dollars per hour for final product.

### HISTORY

Media designed for television, live theater, or film has evolved to produce a variety of different styles of content. All of these mediums are dominated by content production mechanics that make delivery of continuous multi-hour content cost prohibitive. This in combination with the limited attention spans of viewers has generally put an upper limit of several hours on any presentation. Additionally, long duration content can suffer from fundamental human endurance limits—actors must eat and sleep, production crews must be relieved periodically. Traditional theatrical based content for television and film broadcast are universally partitioned into modest time segments, typically ranging from a length of seconds for informational announcements or advertisements, to longer presentations of 30 minutes to several hours. Content that lasts longer than a few hours is routinely partitioned into smaller segments and delivered in a serialized form (i.e. television soap operas).

The 20th century witnessed the transformation of major industries. Processes that were once purely physical have become purely digital. Publishing and music are good examples. Teams of musicians, an ensemble of instruments, and a hub of big mixing equipment were once routinely used to produce music. Today software emulates every stage of that process—synthesizing sound, sequencing scores, mixing voices and encoding media. A solitary musician can now produce, orchestrate and broadcast a symphony using only a laptop. The same is true of publishing—the web now bypasses typewriters, editors, typesetters, bookbinders and bookstores. A solitary author can create a website in a week that reaches more people in a day than a book can reach in a year.

Equally remarkable are the industries that have missed the digital revolution. The 20th century saw only minor advances for television and film. Today movies are produced the same way they were a century ago, in a highly physical, highly manual way—actors, directors, sets, cameras, and film; movies are still shipped to theaters in tin cans; television is still transmitted using signals designed more than fifty years ago. The assembly line was also invented a century ago to reduce the cost, increase the efficiency, and improve the reliability of manufactured goods. This same process has not yet been transferred to many industries, television and film being one of them.

Ninety-nine percent of all household have at least one TV; nearly half have three or more. TVs are on an average of seven hours a day, with the average viewer watching five hours of programming. This is the age of big bright high-resolution flat panel displays. Very large flat panel displays are now available. Large amounts of bandwidth connect these displays and yet the average TV is off 70% of the day. TVs generally occupy the most valuable real estate inside a home. This invention makes it possible to provide content appropriate for display on a TV that would normally be turned off. This provides a unique position for business operations. This invention makes possible the formulation of a for-profit process that can efficiently supply content that no existing network programming process can supply.

### SUMMARY OF THE INVENTION

Briefly stated, the present invention involves a non-labor intensive method of producing audio visual content using a computation engine and 3D software systems. This automated content production system is preferably implemented using commodity computer hardware and standardized 3D software, either 3D modeling and animation tools or a video game engine. This system substitutes the majority of manual operations found in normal content production operations with a largely autonomous computational process. In order to achieve this high level of automation, a control system is used to script the events in the 3D simulation which, once set in motion, generates content of arbitrarily duration.

The numeric data set used to describe the content is created in either a software 3D modeling and animation tool or the game engine itself. This numeric data set is further augmented with numeric descriptions and methods that control how the elements of the content interact. This interaction can include generalized rule sets or explicit scripting instruction. This augmented numeric data set is used by a computational simulation engine to produce individual 2D images (video frames), synchronized with attendant audio samples, based on the scripted position and direction of a camera's point of view. This content is then converted to a format suitable for streaming to a broadcast network, or optionally written to recording media for later playback. Once configured, the system is capable of producing audio visual content in a largely autonomous fashion.

### BRIEF DESCRIPTION OF THE FIGURES

FIG. 1—This figure shows an autonomous content production system's major numeric data set elements and how they are used to create streaming audio visual transmissions.

FIG. 2—This figure shows the data elements involved in an automated content production system and how external data sources are integrated into scene rendering.

FIG. 3—This figure shows the idealized embodiment for an automated content production system in terms of the various computation resources, forms of data input, control input, how data and control is integrated, the intermediate results of combining inputs, and how the final product is obtained for transmission.

FIG. 4—This figure shows the idealized embodiment for construction of a automated content production system: how computation resources are logically partitioned, where manual input controls the content production process, how digital assets are combined, how content preview is best accomplished, how computationally intensive segments of the production pipeline are partitioned to reduce production cycle times, how integration of partitioned work handled, and what results are obtained in the final audio visual product.

FIG. 5—This figure shows a schematic of the visual result of an example of customized rendering based on a specific configuration of display devices. This also illustrates how broadcast content in for form of 3D descriptions, and the use of such broadcast content by a remote rendering system, allows the presentation devices at a remote location to be fully utilized.

FIG. 6—This figure shows an idealized embodiment of the data flow for a system which incorporates viewer customization of narrative content. The viewer selects the narrative content to be presented, then various automatic and user selected presentation constraints are established which determine the precise nature of the presentation content. These presentation constraints operate on the narrative content as received from the content provider to form the presentation. The data sets being processed are shown in the left section, the controlling elements working with those data sets are shown in the center section, and the data inputs needed to construct and process those data sets by the controlling elements are shown in the right section.

FIG. 7—This figure an example of a virtual world representation of a narrative content and an example of such a representation as stored as output from a physical reality simulation engine in the form of 3D descriptions.

FIG. 8—This figure shows the use of a pre-rendered form of a narrative content in an example of a remote rendering system requesting narrative content, and the response by the narrative content server. The request includes information about what narrative content is being presented, the time frame requested, and each render-instance-object being used to render the narrative content, which the narrative content server uses to determine what data in the stored virtual world history, representing the narrative content being presented, should be returned in the response.

FIG. 9—This figure shows an idealized embodiment of the production of an Unchangeable-Event-List using a physical reality simulation engine as the central element in the generation of the list.

FIG. 10—This figure shows an idealized embodiment of the production of content using a physical reality simulation engine as the central element in the generation of the content, in a manner similar to FIG. 9.

### BRIEF DESCRIPTION OF THE INVENTION

A novel system and method of producing visual, audio and other sensory streams which present a fusion of solely simulated, or combined simulated and real environments in an automated way ideal for continuous transmission, substantially continuous transmission, or long duration recordings. This system and method are designed for producing content that spans much longer periods of time than existing methods of audio visual production and distribution, for example days, months, years, or even decades of substantially continuous production and distribution are possible. Using the means described here, it is possible to create a new style of entertainment or informational content for broadcasting systems.

### DETAILED DESCRIPTION OF THE PREFERRED EMBODIMENT

The present invention is directed to the production of audio visual content designed to leverage the advances in 3 dimensional computer graphics hardware and software to efficiently create audio visual content with reduced manual labor requirements, decreased product delivery times, and low operating cost. The present invention benefits from commodity computer system hardware and software including:
(1) Consumer grade computer system components, in particular consumer grade 3D video cards
(2) Consumer oriented 3D software tools and libraries—modeling, rendering, compositing, physic simulations, procedural generation algorithms and video game engines.
(3) Low cost media for storing or recording content—hard disks and DVDs.
(4) Low cost bandwidth for digital transmission of content generated in this fashion.

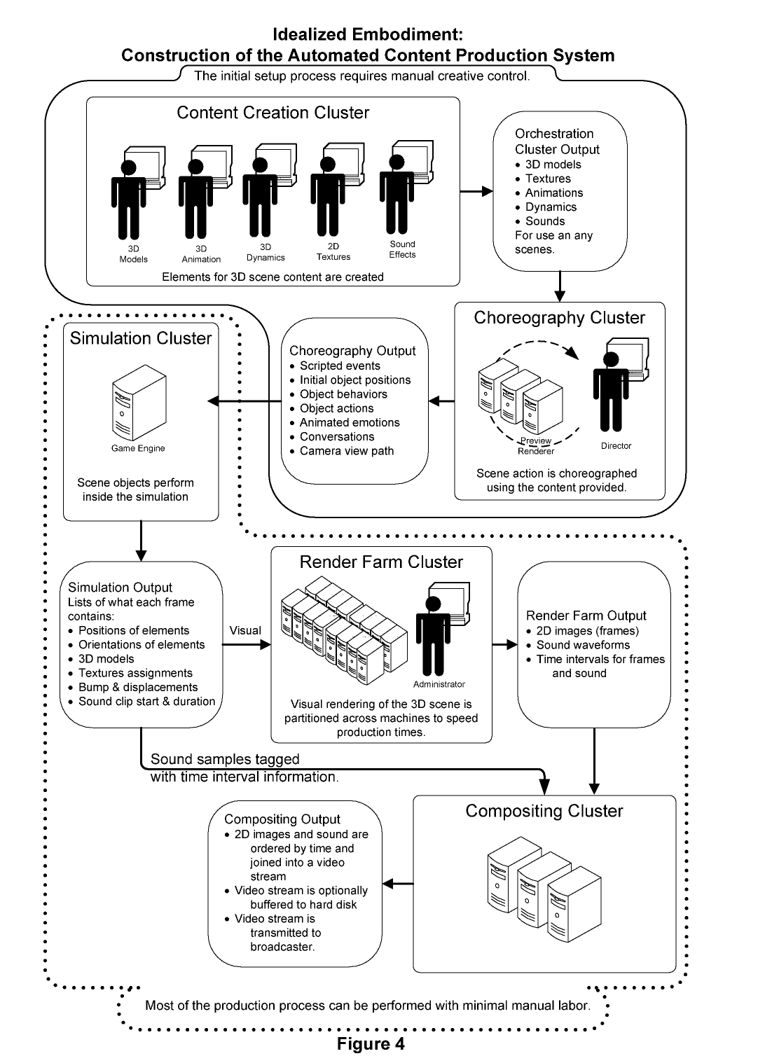

In general, the present invention is preferably implemented using five independent networked computing clusters (see FIG. 4), described in the following paragraphs.

The first computing cluster is devoted to 3D content creation running software for 3D modeling which includes the following elements:
(1) 3D polygon mesh—the shapes of characters, landscapes, foliage, fluids, fire, plasma, etc.
(2) Textures for skinning the 3D polygon mesh—the external 2D visual appearance of the objects (tiger stripes, brick patterns, rock and sand images, clouds swirls, etc). This may include mipmaps.
(3) Texture bump maps—detailed lighting information for textures (things like bark, rivets, veins, cracks, hair, pores, etc.)
(4) Geometry displacement maps—detailed location adjustments for textures.
(5) Light sources—position, color, luminosity changes, movement and other characteristics.
(6) Geometry control points, generally used to control where to morph creatures, bend foliage, ripple water, etc.
(7) Geometry morphing descriptions—used to instruct how individual elements of a 3D mesh are to be modified including vertex weightings, degrees of freedom, etc.
(8) Canned geometry animations.
(9) Geometry model positioning—movement ranges, movement rates, timing, etc.
(10) Material properties associated with the geometry to be used the physics (tensile strength, breaking characteristics, friction, explosiveness), behavioral (attraction, anger, flocking), or dynamics (flame fluttering, water ripples, wind action). These properties are used primarily by rendering subsystems based on game engines.
(11) Sound clips that emanate or occur during model interactions (ambient water gurgling; air rushing, cricket chirps, bird songs, human voices, etc.)
(12) Other scene assets required to compose the final rendered scenes

The second computing cluster is devoted to 3D orchestration for choreographing scene content, character and object interactions, and overall lighting and look. An orchestration cluster preferentially runs an identical version of the simulator producing a lower resolution video output suitable for preview. This simulator will perform the 3D model compositing, bringing together the graphical assets from the creation cluster into fully realized 3D scene. In particular this engine is responsible for simulating the physics, behavior and dynamics of all the objects involved in the scene.

This cluster is used to generate and preview the specific events that will take place in the simulation during final generation of content. The events generated here can be detailed to the degree they specify things like individual footsteps, or they may be high level goals that rely on rule based systems for the specific steps to perform. This orchestration platform may also specify details such as the dynamics of water, weather, fire, or leave those to a physics simulator that will orchestrate them during the simulation phase just prior to rendering. Orchestration also generally specifies camera point of view and movement. The results from the orchestration cluster consist of detailed controls to be applied to the simulation cluster such that the high fidelity renderings it produces match the previewed version. These detailed controls are combined with the digital assets from the creation cluster during operation of the simulation cluster.

The third computing cluster is devoted to simulation of the 3D environment—animating the digital assets produced by the creation and orchestration clusters including simulated behavior (Artificial Intelligence), simulated physics, sound generation (ambient, event driven, periodic), light positioning, and scripting. The simulation cluster produces detailed visual scene rendering instructions for the rendering cluster. It also produces audio content, which due to its computational simplicity can generally be passed directly to the compositing cluster. The visual information passed to the rendering cluster includes but is not limited to: the geometry present in a particular frame; the textures and texture coordinates to use on geometry including mipmaps; bump maps and displacement maps to apply; the position, color, and other qualities of lights; pixel shaders to employ and the textures on which to apply them; vertex shaders and the geometry on which to apply them; and the filters to applied to the final image. In the preferential embodiment this simulation will produce detailed instructions describing the exact locations off all geometry, how the geometry is textured, bump mapped, texture displaced, and lit.

The fourth computing cluster is devoted to rendering the 2D visual images from 3D scene descriptions passed from the simulation platform. This cluster is preferentially implemented as a set of collections of substantially similar machines, each collection running substantially the same rendering software. Each element of this set, that is, each collection of substantially similar machines, is differentiated by their hardware and software capabilities, which is defined by their rendering task requirements. This set may consist of a single collection of machines. Alternatively, this set may consist of more than one collection of machines, each collection specializing in some subset of the rendering process. A very brief list of examples of said subsets is rendering process subsets which specialize in 3D world volumes specific distances from the camera, lighting effects, atmospheric effects, specific 3D model types such as buildings or human figures, backgrounds, and terrain. Each of these machines is tasked with producing individual frames, or a portion of individual frames, for scene descriptions at specified time intervals. The task for an individual machine is therefore to generate a single frame, or a portion of a single frame, in a video and then take the next 3D description to render from a work queue and process it.

In general this rendering operation is the most computationally expensive portion of the production process which is why it is partitioned over a large number of machines. This partitioning is required due to current technological limitations in the computation requirements for rendering scenes. Using 2005 commodity hardware the rendering times per machine for high quality output are generally 1 to 3 orders of magnitude too slow for real time operation. The preferential embodiment of the system benefits from the ease of producing large quantities of content, which is in turn limited by slow rendering times. Partitioning the rendering workload over a compute cluster allows the slow rendering times to be surmounted. There are several options for partitioning the work, including:
(1) Preferentially the frames can be assigned for rendering to any available machine, this division benefits from ease of implementation as well as efficient adaptation to varying render times when scene complexity varies.
(2) The rendering of individual frames can be partitioned modulo the size of the cluster. For example a cluster of five machines can partition the work so that the first machine renders frames 0, 5, 10, 15 while the second machine renders 1, 6, 11, 16, the third machine rendering 2, 7, 12, 17, and so forth.
(3) The rendering of individual frames can be partitioned into time segments across the cluster. For example a cluster of three machines could partition the work into twenty minute time segments for each hour of rendered content—the first machine rendering the first twenty minutes, the second the middle twenty minutes, and the last machine the final twenty minutes.
(4) The rendering of individual frames can be partitioned by scan lines—i.e. two machines can render alternate scan lines for each frame.
(5) The rendering of individual frames can be partitioned by frame area, such that the total frame area is sub divided into smaller areas, and each such smaller area is tasked to a specific machine for rendering.
(6) The rendering of individual frames can be partitioned by 3D spatial volume within the simulated world relative to some location, such as the camera.
(7) The rendering of individual frames can be partitioned by the object, object class, or visual effect to be rendered.
(8) Some combination of the listed work partitioning methods.

Output from the frame rendering compute cluster are preferentially integrated by a separate composing system responsible for ordering frames or scan lines into their natural sequential order. This composing system also performs video stream integration with audio content. The resulting audio visual stream is compressed into a format compatible for transmission to a broadcast hub; typically this is Mpeg2. This encoding is preferentially performed by a hardware accelerator. The content may be stored or buffered for later transmission.

### DETAILED DESCRIPTION OF THE FIGURES

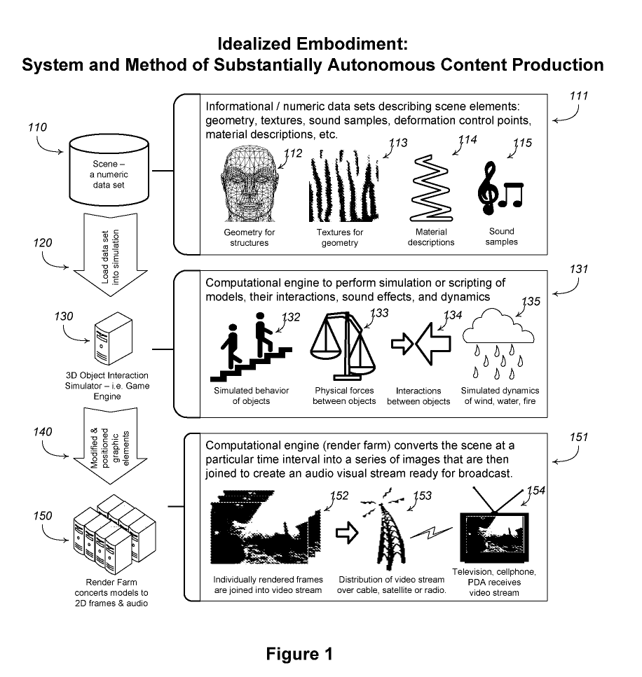

FIG. 1—FIG. 1 shows an autonomous content production system's major numeric data set elements. These numeric data set elements are depicted in three separate groups to show the roles they play in the production process. Scene based elements shown are: 3D geometry generally stored in the form of a triangle or polygon mesh, digital images known as textures for 3D geometry, material properties for 3D geometry groups known as 3D models, and sound samples in the form of digitized audio. The computational engine performing the simulation of the 3D models has numeric data elements shown as: 3D object behavior generally in the form of simple rules, heuristics, or artificial intelligence algorithms; physics forces which may represent real world forces, imaginary forces, or a hybrid of the two; the rules governing the interaction of objects which are generally used to decide what outcomes result (object destruction, new object creation, sound emission, or the modification of object behavior); and the simulated dynamics of air, water, fire, and plasma generally used to create the impression of more realistic physics without performing the associated complex realistic physics calculations. The third section of FIG. 1 depicts the process of integrating numeric results from prior levels; in particular the figure depicts the compositing of individually rendered 2D images of the 3D simulation into an audio video stream suitable for transmission to a broadcast station, and in turn broadcast to television receivers for display to viewers.

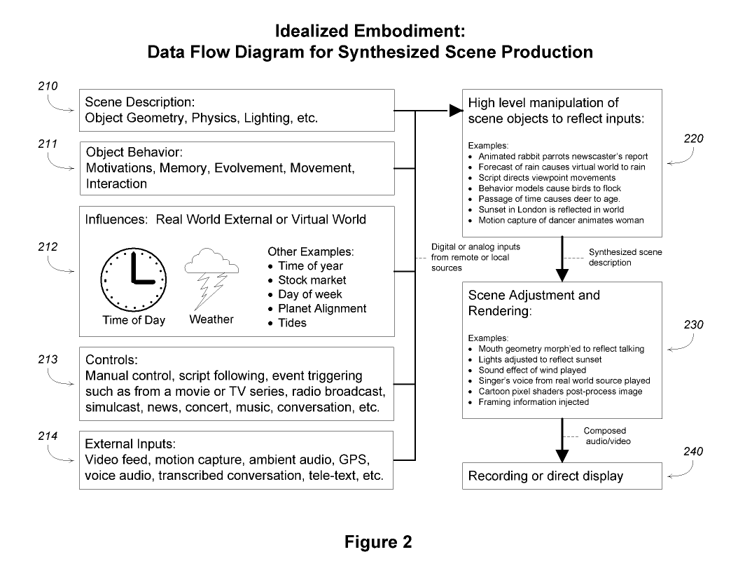

FIG. 2—FIG. 2 shows the data elements involved in an automated content production system—the elements that make up the scene: 3D geometry, physical forces between objects, lighting properties of those objects (i.e. objects that reflect light, are translucent or partially transparent, etc); the behavior of objects (i.e. how they move, what happens when they collide, where they go at different time intervals, etc.); external controls that influence objects (manual controls from a human directing action, external controls from a script that must be followed, real-time events such as those from external sources such as the broadcast of a movie or news show, the movement of mouth geometry to reflect the utterances of a human).

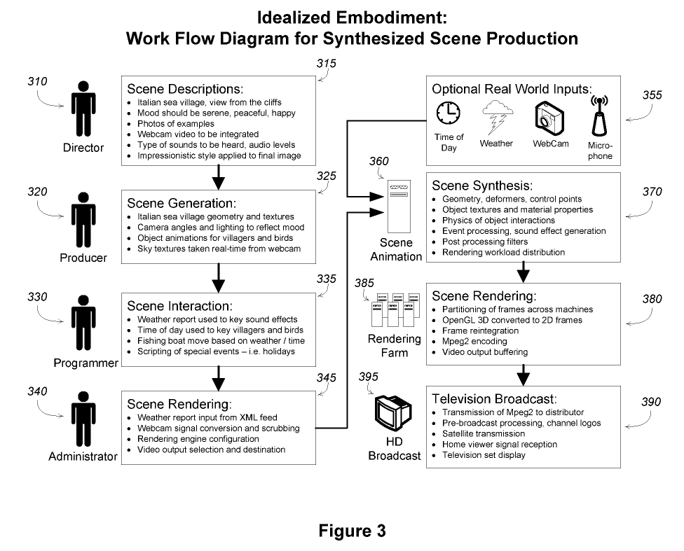

FIG. 3—FIG. 3 shows the idealized embodiment for an automated content production system in terms of the various computation resources involved in automated content production. The resources include high level scene description including overall feel of the final product. This high level description describes the types of sounds, the distance of the sounds from the camera viewpoint, what objects will be visible within the field of view to be rendered, what objects lie outside the field of view, how objects will interact and what events will take place. The scene generation related assets consist of the specifics of the 3D geometry used to depict scene objects, the textures used to skin those objects including mipmaps if applicable, the specifics of lighting for those objects including which objects produce or reflect light. The scene interaction section describes the interaction between objects, which interactions produce sound effects, which objects produce ambient or spontaneous noises, which objects will move and under what circumstances they move, and the effects of external control in the form of scripted action or the integration of real world measurements, images or other digital sources. The scene external input section controls how real world measurements, real world images, manual control, and other later stage influences integrate into the confluence of scene elements. The optional real world inputs section depicts some example inputs that could be used to effect textures used to skin 3D models, the type of sound effects or ambient noises that could be produced, and the type of lighting to be used during rendering. In general, any real world measurement can be translated to some effect inside the simulation and its resulting rendered output. The scene synthesis section depicts the elements used to combine the various input elements. A computation simulation is the underlying method for performing scene synthesis. Alternatively a fully scripted simulation is possible (not shown). The scene rendering section depicts the partitioning of the workload of rendering and integrating the rendered frames into a final audio video stream. The last section depicts the means of moving the audio visual stream to the destination device, a television set being only one example of the various devices capable of receiving the broadcast.

FIG. 4—FIG. 4 shows the idealized embodiment for each of the subsystems (clusters) in an implementation of an automated content production system. The implementation is partitioned at the high level into portions involved in the preproduction stage and the continuous production stage. The preproduction stage is itself partitioned between the construction process for digital assets to be used in the simulation and the choreography of action scripted for the simulator to follow during the production stage. The choreography cluster is depicted with a separate preview machine cluster used to rehearse the action at a lower fidelity than that available by the full render farm. This preview process is used to sort out the dynamics of the various elements before committing the script for full production.

FIG. 4 also shows a second section that depicts the process of producing final content destined for broadcast. The simulation cluster is generally a single computational resource that produces a detailed description of the movements, lighting changes, sound effects and other incremental changes derived by the simulator in the following of the scripted action. These incremental changes are preferentially partitioned by the frame rate so that all the action that happens between one frame and the next are bundled into the description that will be passed to one of the compute elements in the render farm. These bundled descriptions are distributed across the render farm. The render farm is preferentially chosen to have enough computational elements to render at a speed in excess of real-time. The final element in this section if the composition cluster which performs the re-integration of the distributed frames from the render farm. The results from this composition cluster will be the raw or encoded audio visual stream, preferentially high definition output.

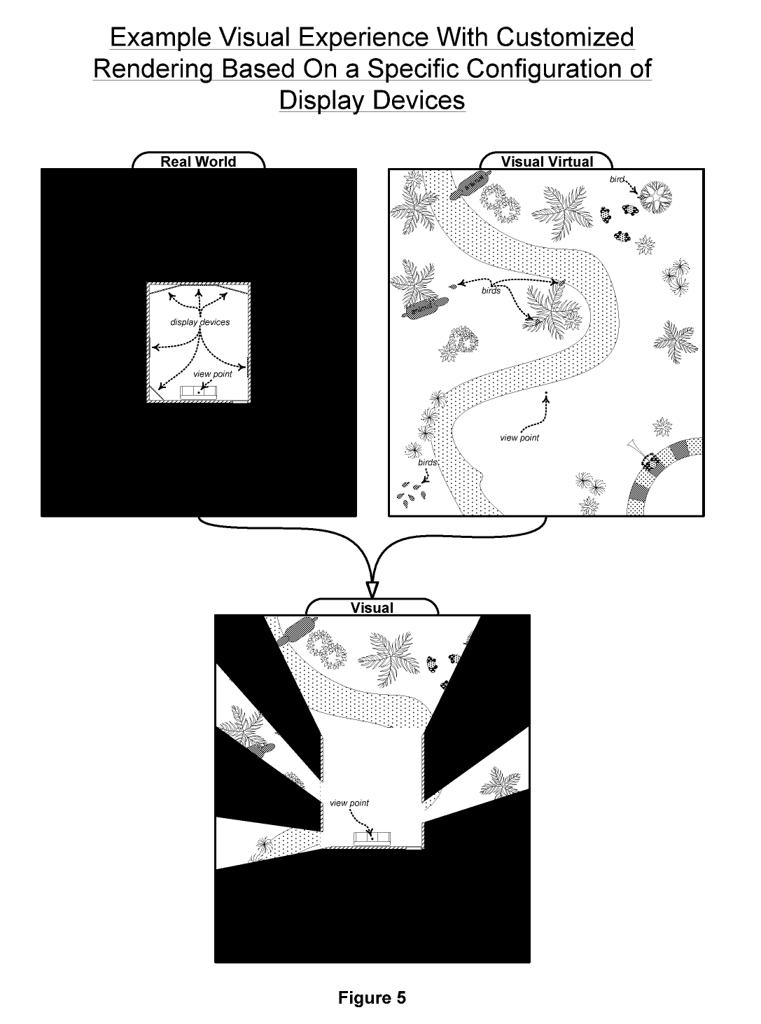

FIG. 5—FIG. 5 shows a schematic representation of combining a specific configuration of display devices with a narrative content represented as 3D descriptions and the resultant customized rendering. The boxed section labeled Real World represents the local viewing environment of a rectangular room with a set of display devices attached to the walls. Ideally the narrative content presentation would utilize all of these display devices. The boxed section labeled Visual Virtual represents the narrative content in its 3D form. It is received from the narrative content provider in this form. Below, in the boxed section labeled Visual, is shown the resultant combination of renderings produced by the rendering system. Each display device is supplied with rendered content appropriate to its position in the room and its position relative to the viewer. This is possible because the narrative content server stores the narrative content in a pre-rendered three dimensional form, and supplies the narrative content in a similar form to the local rendering system for presentation on the local presentation devices.

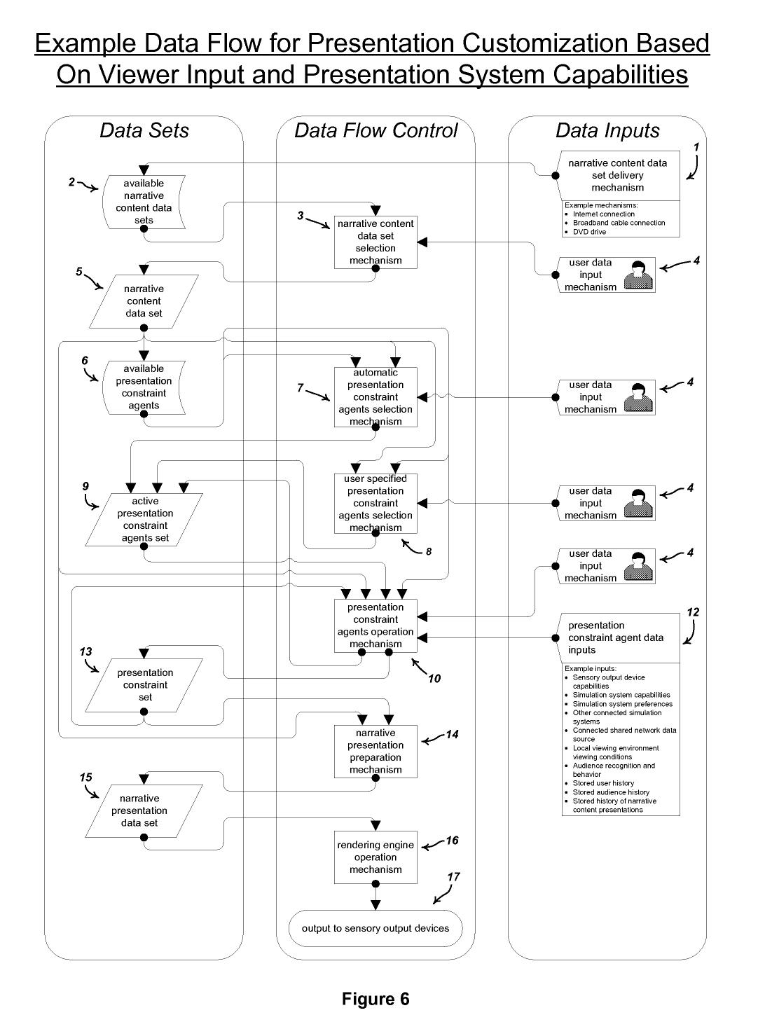

FIG. 6—This figure shows an idealized embodiment of the flow of data within the local narrative content presentation viewing area rendering system from the initial selection of a narrative presentation to the final rendering of the presentation to the sensory output devices. The data sets being processed are shown in the left section, the controlling elements working with those data sets are shown in the center section, and the data inputs needed to construct and process those data sets by the controlling elements are shown in the right section. The data flow begins with the narrative content data set delivery mechanism 1 which allows the rendering system access to narrative content provided by various narrative content suppliers. Said mechanism inputs narrative content in the form of narrative content data sets into the rendering system. The rendering system may have more than one said mechanism. The portion of said mechanism which connects said mechanism with a narrative content supplier may consist of an internet connection, a connection to a broadcast network like a cable or satellite provider, a DVD drive or other data storage device, or some other device or service. The available narrative content data sets 2 is the set of narrative content data sets that are available for presentation on this rendering system. Said data sets are supplied from the input from the narrative content data set delivery mechanism 1. The narrative content data set selection mechanism 3 selects the narrative content data set, from among the available narrative content data sets 2, to be presented to the audience. Said selection is made either by the rendering system or from the user data input mechanism 4. The user data input mechanism 4 allow the audience to select various options presented by the rendering system. Typically those options are presented on one or more of the connected sensory output devices 17. Selection of said options allow the audience to communicate their preferences to the rendering system. Said user data input mechanism may consist of a connected keyboard or pointing device, voice recognition device or mechanism, or some other unspecified mechanism or device. The narrative content data set 5, selected by the narrative content data set selection mechanism 3, is a numerical data set representing a narrative. Said data set may be a substantially complete description of all elements of the presentation, such as a detailed description of the virtual world wherein the narrative belongs, a detailed description of the appearance, movement and dialog of all characters, and a detailed time and space description of the narrative order of presentation, or said data set could be a less complete description containing descriptions of only certain elements, such as only the characters dialog and gender. The available presentation constraint agents 6 is the set of all presentation constraint agents available for use with the selected narrative content data set 5. Various other factors may also determine said agents, such as rendering system capabilities, connected sensory output devices, and subscription level. The automatic presentation constraint agents selection mechanism 7 enables for operation a set of presentation constraint agents (agents) from the available presentation constraint agents 6. Said automatic presentation constraint agents consist of a set of agents selected for operation for every presentation, a set of agents selected for operation for every presentation of the selected narrative content data set 5, and possibly other unspecified sets of agents. Any necessary parameters of said selected presentation constraint agents are set either by the rendering system or from data input from the user data input mechanism 4. The user specified presentation constraint agents selection mechanism 8 enables for operation a user specified set of presentation constraint agents from the available presentation constraint agents 6. Said presentation constraint agents are selected by the audience, using the user data input mechanism 4, and any necessary parameters of said selected presentation constraint agents are set either by the rendering system or from data input from said user data input mechanism. The active presentation constraint agents set 9 (agents set) is the set of presentation constraint agents that are currently active and under operation by the presentation constraint agents operation mechanism 10. Said agents set is specified by the automatic presentation constraint agents selection mechanism 7, the user specified presentation constraint agents selection mechanism 8, and possibly by certain active presentation constraint agents under operation by the presentation constraint agents operation mechanism 10. Each presentation constraint agent (agent) of said agents set consists of the algorithm defining the functionality of said agent (software code component) and a current state data set containing state information for the current operational state of said agent (software data component). Said software code and data components may be unique for each instance of each agent or they may be shared among various agents to various degrees. The presentation constraint agents operation mechanism 10 (mechanism) operates all enabled presentation constraint agents (agents). Said agents are defined by the active presentation constraint agents set 9. The operation of said agents creates and modifies the presentation constraint set 13, which is used to determine exactly how to present the selected narrative content on the connected sensory output devices 17. The operation of said agents may select for operation additional presentation constraint agents from the available presentation constraint agents 6 and may remove presentation constraint agents from among said active presentation constraint agents set. Said agents use the narrative content data set 5 and the existing presentation constraint set 13, along with possible audience preferences using the user data input mechanism 4, and possible presentation constraint agent data inputs 12. Said mechanism begins operation during preparation for the presentation and continues operation during the presentation to reflect any changes occurring to said presentation constraint set, possible said audience preferences, and possible said presentation constraint agent data inputs. The presentation constraint agent data inputs 12 consists of specific data provided for the use of operating presentation constraint agents for their use in determining the presentation constraint set. Said specific data may be obtained from internal data sources already present and needed by other mechanisms of the rendering system, such as the capabilities of the sensory output devices, the capabilities of the rendering system, or stored presentation history. Said specific data may be obtained from external data sources already connected to and needed by other mechanisms of the rendering system, such as an internet connection or other rendering systems. Said specific data may be obtained from external data sources specifically for the use of presentation constraint agents, such as various passive and active sensors of local viewing environment conditions or audience behavior. The presentation constraint set 13 consists of the set of presentation constraints created by the operating of presentation constraint agents operation mechanism 10. Said presentation constraints are used to determine the exact nature of the presentation. Said presentation constraints limit the scope of the presentation space within various presentation domains. The intersection of said scope limited presentation domains for each presentation domain determines the presentation that will be used for that presentation domain. The narrative presentation preparation mechanism 14 (mechanism) creates and modifies the narrative presentation data set 15 using the presentation constraint set 13 and the narrative content data set 5. If said presentation constraint set is not specific enough to determine said narrative presentation data set then said mechanism automatically selects sufficient presentation constraints to allow determination of said narrative presentation data set. Said mechanism begins operation during preparation for the presentation and continues operation during the presentation to reflect any changes occurring to said presentation constraint set. The narrative presentation data set 15 is the fully formed definition of the presentation in the format specified by the rendering engine operation mechanism 16 and determined by the narrative presentation preparation mechanism 14. Said narrative presentation data set is typically a virtual world definition consisting of specifications over the presentation time span of: a set of 3D model definitions, the placement, animations, actions and interactions of those 3D models, a set of specifications of the physics of the virtual world, and various other appearance, temporal and spatial definitions required to define the rendering of the virtual world to the sensory output devices. The rendering engine operation mechanism 16 uses the fully formed definition of the presentation in the form of the narrative presentation data set 15 to render the said presentation to the set of connected sensory output devices 17.

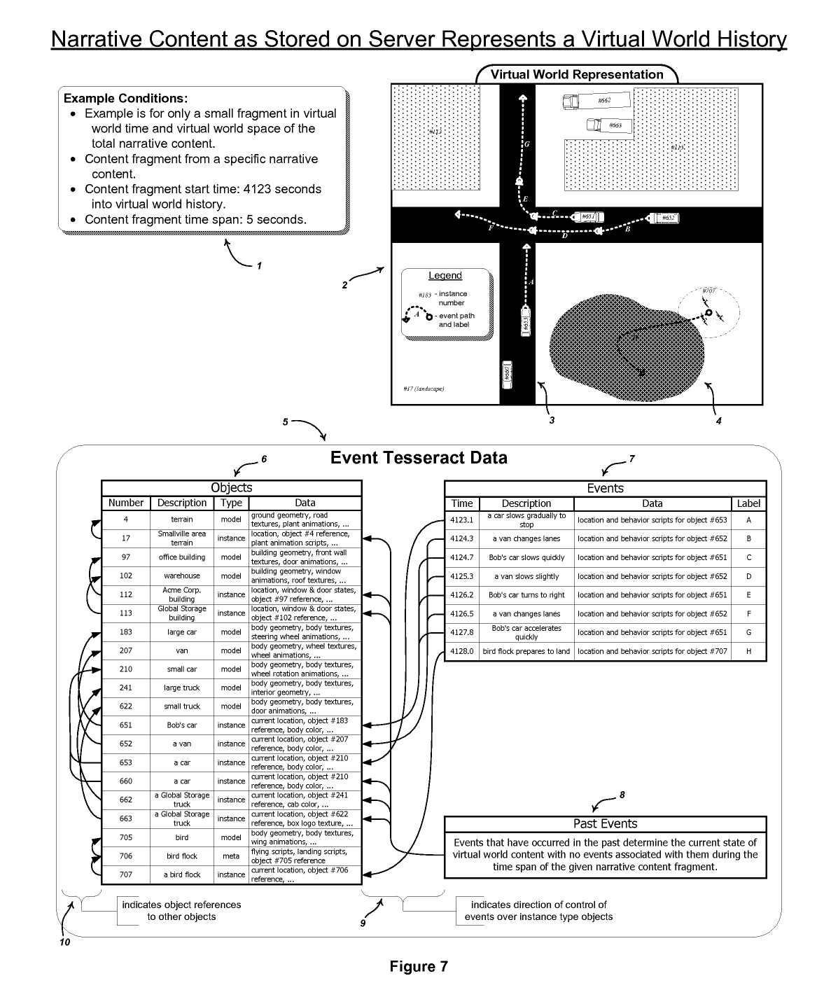

FIG. 7—FIG. 7 describes how the narrative content for a particular story is represented as a virtual world history. The narrative content is stored on the narrative content server as a table of objects used to represent the virtual world and a table of events used to represent the history of the virtual world. An example representation of a virtual world with a short history is shown, along with the data tables used to construct that virtual world and its history. The list Example Conditions 1 details the assumed conditions for the example virtual world history. It notes that the example is only for a small fragment in time and space of a typical narrative content. The example is from a specific narrative content, and the history fragment shown begins at a specific time into the narrative content (4123 seconds) and spans a specific time interval (5 seconds). The Virtual World Representation 2 schematic represents the visual portion of the narrative content fragment. All objects used by events to represent the virtual world (instance objects) are labeled with their object number. The landscape instance object is shown with two intersecting roads 3 and a lake 4. The landscape would typically include much more detail such as ground cover, rocks, soil, trees, etc. The other objects making up this virtual world are four cars, two trucks, two buildings, and a flock of birds. Objects which have events controlling their location in the example time span have the effect on their location shown for each event. Each of these events is represented as a labeled dashed line showing the path of the corresponding object determined by that event. The Event Tesseract Data group 5 contains the event tesseract data which the Virtual World Representation is constructed from. This data represents a fragment of a narrative content. Event tesseract data includes all objects and actions which exist in the narrative content. This fragment includes only those objects and actions which are visible in the Virtual World Representation schematic. The Objects table 6 contains the objects used to construct the virtual world. Each object entry in the table is described by a Number, Description, Type, and Data section. The Number section contains a unique number for that object which is used to reference that specific object from other objects or events. The given numbers have gaps, indicating other objects not included in this table because they exist outside of the given virtual world history fragment. The Description section contains a short description of the object. This description is for reference only and is not included in the event tesseract data. The Type section contains the object type: instance, model and meta. The Data section contains a description of some of the data for that object. This data typically may include a set of behaviors, locations, geometry, textures, animations, animation states, sounds, and references to other objects. The Events table 7 contains the events used to construct history of the virtual world. These events exert control over the objects in the virtual world, such as when each instance object is created and deleted, and its location and behavior at any given time. The events are listed in order of increasing time. Each event entry in the table is described by a Time, Description, and Data section. The Time section contains the start time for the event. At that time in the virtual world history this event is triggered. The Description section contains a short description of the event. This description is for reference only and is not included in the event tesseract data. The Data section contains a description of some of the data for that event. This data typically may include a reference to an instance object, and scripts controlling the location and behavior of that instance object over a period of time. The Label section contains the label for the corresponding event path line in the Virtual World Representation schematic. This label is for reference only and is not included in the event tesseract data. The Past Events table 7 represents events which had start times before the start of the given virtual world history fragment and which further establish objects which otherwise have no events in the given virtual world history fragment but never the less exist in the given virtual world history fragment. The directed lines in the group 9 represent the direction of control that events have over objects, and that each event has over the object or objects which it controls. The directed lines in the group 10 represent the direction of reference that objects have to other objects. In this case instance objects have references to model or meta objects containing behavior scripts and 3D geometry. More than one instance object may share the same model or meta object. Meta objects may reference model objects and other meta objects.

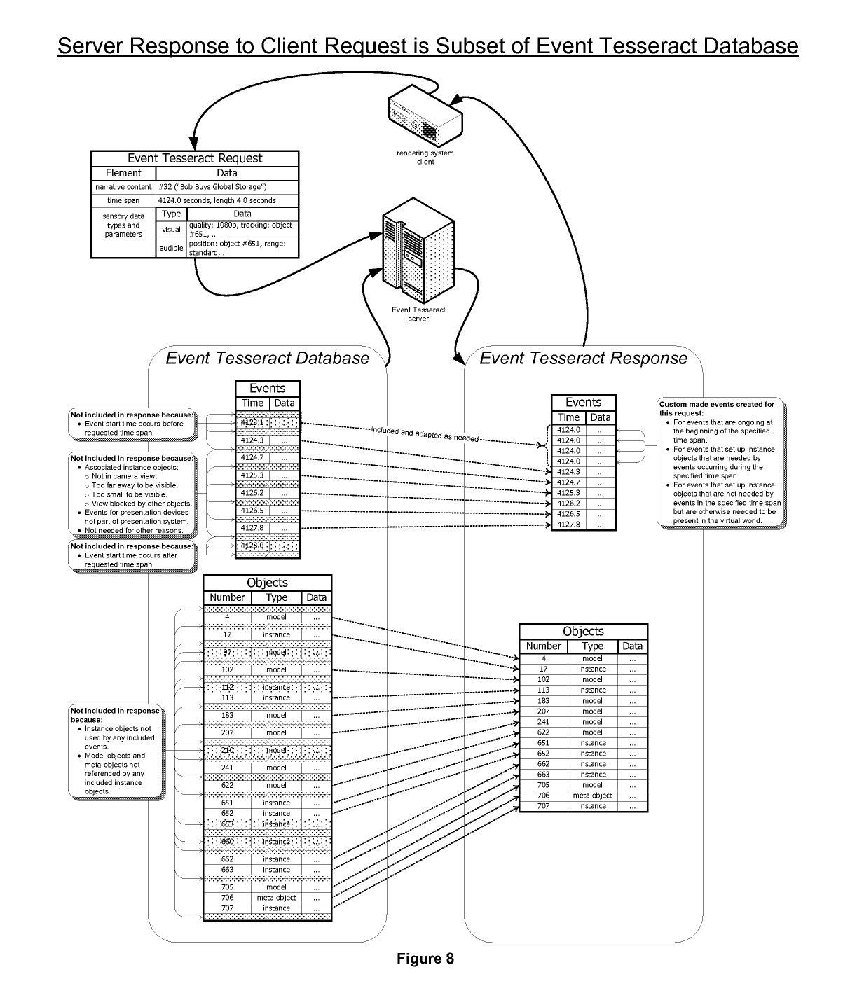

FIG. 8—FIG. 8 shows an example narrative content data request by a rendering system client remote from the narrative content data server (Event Tesseract server). The client constructs a request for narrative content, shown in the table Event Tesseract Request, containing an identifier representing which narrative content is being presented, the time span of the virtual world history being requested, and a list of render-instance-objects. These render-instance-objects specify what sensory output data types to return and indicate what areas of the virtual world to include. This request is sent to the narrative content server, which uses the information to parse through the event tesseract database, shown in the section labeled Event Tesseract Database. It constructs a response containing only the events and objects relevant to the event tesseract request, so that events which happen at times outside the given time span, and events which happen out of view of the list of render-instance-objects, are not included in the response. These relevant events and objects are used to form the event tesseract response, shown in the section labeled Event Tesseract Response, which has a form similar to the event tesseract database. This response is transmitted to the rendering system client where it is used to render the presentation.

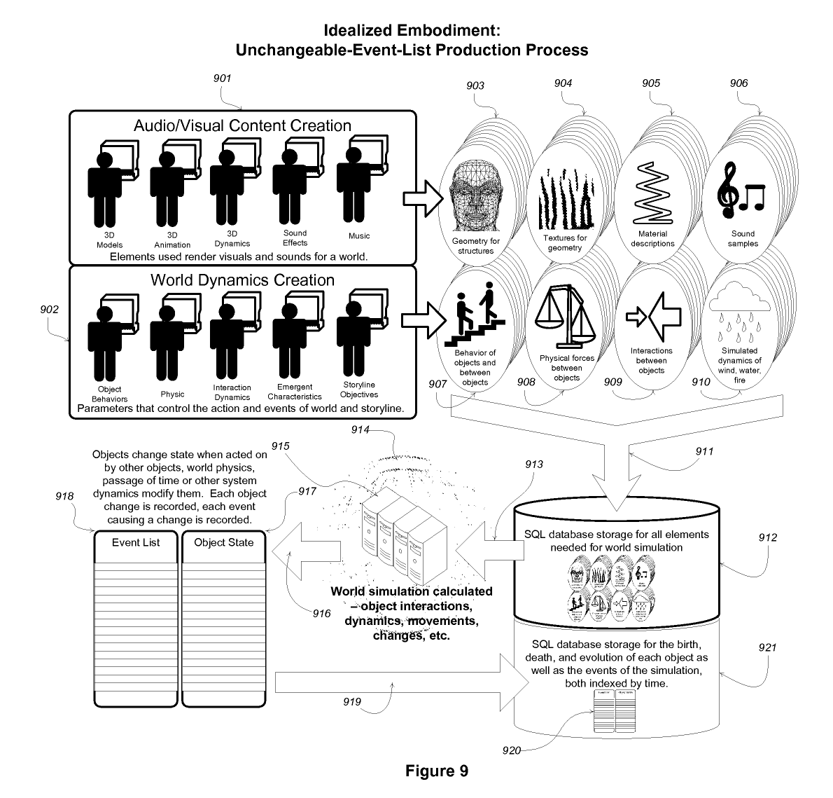

FIG. 9—This figure shows the idealized embodiment of the Unchangeable-Event-List production process. Audio/Visual Content Creation 901 depicts 3D artists, digital musicians, model animators and sound engineers creating elements that will be entered into a SQL database for use in a world simulation. World Dynamics Creation 902 depicts artificial intelligence programmers, physics engineers, object modelers, emergent system analyzers and storyline script writers creating elements that will be entered into a SQL database for use in a world simulation. Geometry for structures 903 is one of many elements used for generating both the visual, physical, audio, tactile and other characteristics of a simulated 3D world. Geometry here is typically represented as a 3 dimensional interconnected mesh of 2 dimensional triangles. There are other representations including: splines, procedural, and constructive solid geometry. Textures for geometry 904 depicts a 2 dimensional image which is mapped onto 3 dimensional structures to create a visual appearance for a 3D object. Material descriptions 905 are used to describe properties of elements in a world simulation which include, but are not limited to: mass, magnetism, charge, hardness, reaction to impact, flavor, sound generation, roughness, or heat. Sound samples 906 depicts numeric representations of audio waveforms that will be used during the world simulation. Behavior of objects and between objects 907 depicts rules, scripts, heuristics or other indicators for changing the attributes of objects or for operating when objects interact. Physical forces between objects 908 depicts the operations that are performed during a simulation on elements that represent forces of nature as defined by the world or universe defined. Generally these forces are close analogs of real world forces which includes but is not limited to: gravity, electromagnetism, chemical, or nuclear. Interaction between objects 909 depicts the rules that apply when two or more objects in the simulation interact. Simulated dynamics of wind, water and fire 910 depicts interactions between the environment and objects in the environment. Arrow 911 depicts the operation of storing the elements created for a simulation into a SQL database. Storage unit 912 depicts an SQL database storing the elements to be used in a simulation. Arrow 913 depicts the transfer of the elements required for the simulation. Globe 914 depicts an abstracted world or universe being simulated on computers. Computer cluster 915 depicts the computers used to simulate the world or universe described by elements stored in the SQL database 912. Arrow 916 depicts the transfer of information describing the events and objects as resolved by the simulation of the world or universe. Table 917 depicts a list of objects or elements descriptions produced by the simulation. These descriptions might include absolute or relative time indicators, 3D coordinates or other attributes to assist in the processing of objects during later stages of operation. Table 918 depicts a list of the events involving objects in the simulation. These events typically describe one or more objects and the action between or attribute change among them produced by the simulation. Arrow 919 depicts the storing of the event list and object states into the same SQL database 912 to be used later during a translation to an encoding suitable as input to sensory output devices. Table 920 represents the combined lists of events and objects which become the Unchangeable-Event-List. Storage unit 921 depicts the fully augmented SQL database including SQL database 912 which holds descriptions of all the elements and the history of events recorded during the simulation of the world or universe.

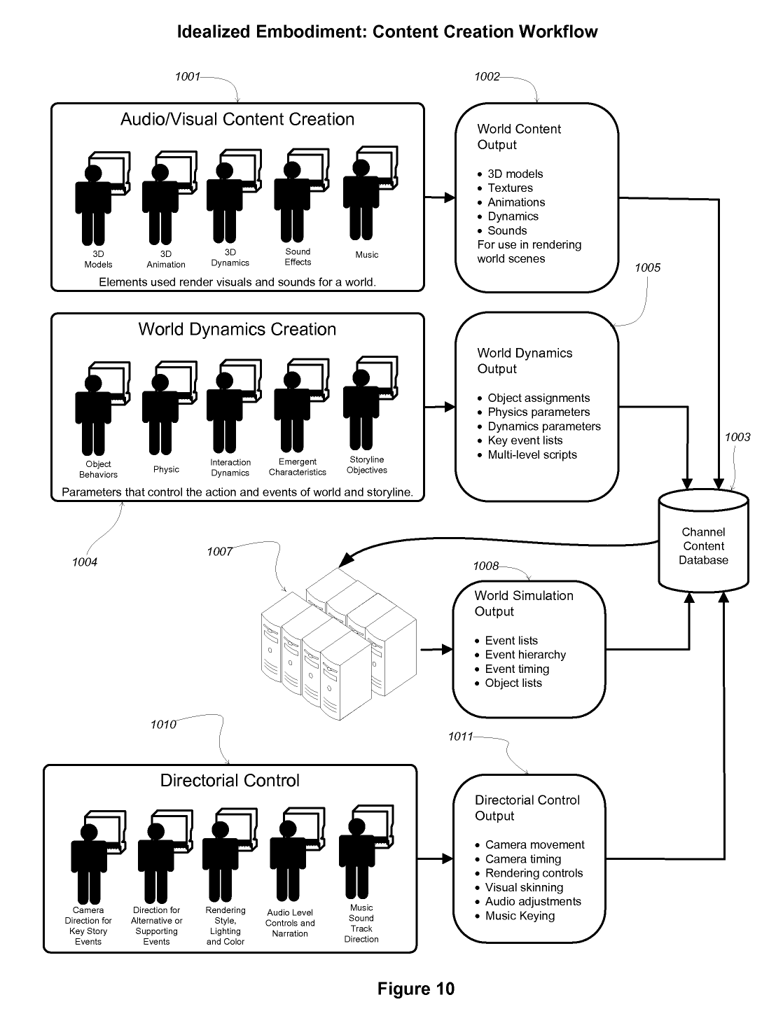

FIG. 10—This figure shows the idealized embodiment of the content creation workflow utilizing a physical reality simulation engine. Audio/Visual Content Creation 1001 depicts 3D artists, digital musicians, model animators and sound engineers creating elements produced as part of a work flow or assembly line process to create content. The work output of Audio/Visual Content Creation 1001 is depicted here as a set of elements for use in rendering world scenes using a world simulator. This World Content Output 1002 may include, but is not limited to: 3D models of object using triangle mesh, splines, procedural, and constructive solid geometry; textures represented as 2D bitmaps, procedural textures represented as formulas for creating pixel values; pixel shader code for creating surface visual values; vertex shader code for augmenting geometric descriptions; animations of geometric shapes; dynamics for lighting, reflections, shadowing, blurring, obscuring, desaturating images; dynamics for producing sensory experiences such as tactile, olfactory, heat, or sound. World Content Output 1002 is stored in the Channel Content Database 1003 for use by other stages of the work flow or assembly line. World Dynamics Creation 1004 depicts artificial intelligence programmers, physics engineers, object modelers, emergent system analyzers and storyline script writers creating elements produced as part of a work flow or assembly line process to create content. World Dynamics Output 1005 depicts the results of World Dynamics Creation 1004. The output consists of object assignments which represent the values associated with 3D elements including information such as: location, 3D model, textures to use for the 3D model; physics parameters such as mass, magnetism, charge, hardness, reaction to impact, flavor, sound generation, roughness, or heat; dynamics parameters such as movement, animations, vibrations, undulations, ripples, and other dynamic characteristics; key event lists which describe important events that guide the simulation, specific events which are used to interpolate intermediate events not specified, meta descriptions of events used to derive more detailed events necessary to achieve the meta-description; multi-level scripts which describe rules for interaction at various levels of detail for objects or elements of the 3D simulation. World Dynamics Output 1005 is added to the stored information in the Channel Content Database 1003 for use by other stages of the work flow or assembly line. Computer cluster 1007 represents hardware used to compute the simulation of a world. Typically such hardware includes many compute elements networked together to distribute calculations. Results of the simulation is the World Simulation Output 1008 which contains event-lists, event hierarchy which describes how events are related, event timing which indicates when and for how long events were calculated to exist in the simulation, and object lists which describe the objects or elements the events acted on during the simulation. World Simulation Output 1008 is added to the stored information in the Channel Content Database 1003 for use by other stages of the work flow or assembly line. Directorial Control 1010 depicts the process of camera position selection for observing events recorded in the World Simulation Output 1008. This directorial control also includes partitioning the events to observe by cameras into those that are part of a primary viewing of events and those that are optional or alternative viewings of the same or different events. Directorial Control can include information describing how translation of the events to an encoding suitable for sensory output devices should be performed. This may entail such descriptions as how translation of the visual should look or should be rendered. Directorial Control can also include audio level or other sensory level adjustments for events so as to improve such traits as viewer recognition, delivery style or comprehension. Additionally Directorial Control may include selection of music to accompany events being shown. The Output of Directorial Control 1011 is added to the stored information in the Channel Content Database 1003 or use by other stages of the work flow or assembly line process. Channel Content Database 1003 depicts the combined information for the four stages depicted.

Definition List 1

| Term | Definition |
|---|---|
| 3D Geometry | Any of the standard techniques for |
| | representing shapes in 3 dimensional |
| | space including: NURBS, CSG, Polygons, |
| | Polygon Mesh, Subdivision Surfaces, or |
| | Implicit Surface. |
| 3D Object | One or more pieces of 3D geometry that |
| | represent an abstract object such as a |
| | tree, human, mountain, flame, river, etc. |
| NURBS | NURBS, short for non uniform rational B- |
| | spline, is a computer graphics technique |
| | for generating and representing curves |
| | and surfaces. |
| CSG | Constructive solid geometry (CSG) is a |
| | branch of solid modeling that deals with |
| | representations of a solid object as a |
| | combination of simpler solid objects. It |
| | is a procedural modeling technique used |
| | in 3D computer graphics and CAD. |
| Polygon | A polygon is a closed planar path |
| | composed of a finite number of |
| | sequential line segments. The straight |
| | line segments that make up the polygon |
| | are called its sides or edges and the |
| | points where the sides meet are the |
| | polygon's vertices. If a polygon is simple, |
| | then its sides (and vertices) constitute |
| | the boundary of a polygonal region, and |
| | the term polygon sometimes also |
| | describes the interior of the polygonal |
| | region (the open area that this path |
| | encloses) or the union of both the region |
| | and its boundary. |
| Subdivision Surfaces | In computer graphics, subdivision |
| | surfaces are used to create smooth |
| | surfaces out of arbitrary meshes. |
| | Subdivision surfaces are defined as the |
| | limit of an infinite refinement process. |
| | The fundamental concept is refinement- |
| | by repeatedly refining an initial |
| | polygonal mesh, a sequence of meshes |
| | is generated that converges to a |
| | resulting subdivision surface. Each new |
| | subdivision step generates a new mesh |
| | that has more polygonal elements and is |
| | smoother. |
| Polygon Mesh | A set of one or more polygons generally |
| | used to depict a solid 3D object. |
| Implicit Surface | In mathematics and computer graphics, |
| | an implicit surface is defined as an |
| | isosurface of a function, the set of points |
| | in the 3 dimensional space that satisfy |
| | an equation. |
| Mpeg2 | A standard for compressing digital audio |
| | visual stream commonly used on DVDs |
| | and for digital television broadcasts. |
| Mpeg4 | An advanced standard for compressing |
| | digital audio visual stream commonly |
| | used on DVDs and for digital television |
| | broadcasts. |
| Audio Visual Stream | A time based sequence of analog or |
| | digital information used to represent |
| | audio visual content. |
| PDA | The abbreviation for Personal Digital |
| | Assistant, a portable computer system. |
| 3D Display Device | A device that renders a physically 3D |
| | presentation of 3D information. |
| 3D Modeling Software | A software application for modeling and |
| | rendering three-dimensional graphics |
| | and animations. |
| Numeric Data Set | A collection of related numeric values for |
| | use by software systems. |
| Texture | Textures are 2D images used to map 3D |
| | geometry to add realism to a computer- |
| | generated graphic. This 2D image (the |
| | texture) is added (mapped) to a simpler |
| | shape that is generated in the scene, like |
| | a decal pasted to a flat surface. This |
| | reduces the amount of computing |
| | needed to create the shapes and |
| | textures in the scene. |
| Mipmap | In 3D computer graphics texture |
| | mapping, MIP maps (also mipmaps) are |
| | pre-calculated, optimized collections of |
| | bitmap images that accompany a main |
| | texture, intended to increase rendering |
| | speed and reduce artifacts |
| Bump map | Bump mapping is a perturbation to the |
| | surface normal of a 3D object being |
| | rendered to modify the illumination |
| | calculation. |
| Pixel or Vertex Shader | Vertex and pixel (or fragment) shaders |
| | are algorithms that are executed once |
| | for every vertex or pixel in a specified 3D |
| | mesh. |
| Camera Viewpoint | Camera viewpoint is term referring to |
| | the abstract location of a virtual camera |
| | in a virtual 3 dimensional scene. Since |
| | the scene is entirely simulated using |
| | abstract mathematics there is no |
| | physical camera. |
| Audio Sequences | Audio sequences refers to a digital or |
| | analog encoding of sound waveforms. A |
| | series of these encodings can be |
| | decoded by electronic equipment to |
| | reproduce the sounds originally |
| | represented by the encodings. |
| Video Sequences | Video sequences refers to digital or |
| | analog encoding of visual images or |
| | electromagnetic wave fronts. A series of |
| | these encodes can be decoded by |
| | electronic equipment to reproduce the |
| | visual images or electromagnetic wave |
| | fronts originally represented by the |
| | encodings. |
| Audio Visual Content | The combination of audio sequences |
| | with video sequences in an encoded |
| | form such that the sound is |
| | synchronized with the visual. Examples |
| | of codexes used to encapsulate audio |
| | visual content include Mpeg2, DivX, Xvid, |
| | and Quicktime. |
| Rigid Body | In physics, a rigid body is an idealization |
| | of a solid body of finite dimension in |
| | which deformation is neglected. In other |
| | words, the distance between any two |
| | given points of a rigid body remains |
| | constant regardless of external forces |
| | exerted on it. |

Definition List 2

| Term | Definition |
|---|---|
| Physical reality | A software component which simulates |
| simulation engine | to some degree of fidelity a defined |
| | physical reality system. Said physical |
| | reality system may or may not be based |
| | on the existent real world. Said physical |
| | reality system is composed of qualities |
| | which define said system. Said qualities |
| | may include some of the qualities of the |
| | existent real world, such as time, |
| | bounded or unbounded 3D flat or curved |
| | space, physical objects, various materials |
| | each with their own physical properties, |
| | electromagnetic forces, gravity, |
| | interaction between objects, and other |
| | real world qualities. Said qualities may |
| | also include qualities which may or may |
| | not be qualities of the existent real |
| | world, such as additional spatial |
| | dimensions, hyperspace, non-real |
| | forces, parallel universes, non-real |
| | materials with arbitrary properties, and |
| | other arbitrary qualities. The operation |
| | of said world simulator typically consists |
| | of an initialization phase, where the |
| | parameters of the qualities of the |
| | physical reality system are initialized, |
| | and the initial state of the physical reality |
| | is set, such as object locations and |
| | physical properties defined. Then the |
| | physical reality is simulated over one of |
| | its said qualities, typically time. Methods |
| | are available to arbitrarily change the |
| | state of the simulated physical reality |
| | during the simulation interval. Methods |
| | are available to store the state of the |
| | simulated physical reality during the |
| | simulation interval. Methods are |
| | available to extract useful information |
| | during the simulation interval, such as a |
| | simulated view from a camera. Typical |
| | examples of a physical reality simulation |
| | engine are 3D video game engines, 3D |
| | modeling programs, and 3D rendering |
| | program. |
| sensory output device | A device the purpose of which is to |
| | produce output receivable by at least |
| | one sense. Said output is substantially |
| | spatially accurate and is determined and |
| | controlled by input provided in a form or |
| | forms specified by said device. |
| sensory output device | A classification based on the sense |
| type | which the device is intended to be |
| | output to. |
| sensory output device | Output characteristics or specifications |
| capabilities | of a sensory output device. May include |
| | the spatial dimensions, spatial range, |
| | spatial resolution, update rate, and other |
| | capabilities specific to the sensory |
| | output device type. |
| presentation | A showing of the content under |
| | consideration. |
| presentation device | A sensory output device with which the |
| | viewer experiences the presentation. |
| | Typically examples are a display device |
| | or sound output device. |
| display device | A sensory output device the output of |
| | which is receivable by the sense of |
| | sight. A typical display device is a |
| | television monitor. |
| 3D display device | A display device which depicts the visual |
| | information in three dimensions. |
| sound output device | A sensory output device the output of |
| | which is receivable by the sense of |
| | hearing. Typical sound output devices |
| | are a speaker, a set of stereo speakers or |
| | a surround sound system. |
| olfactory stimulation | A sensory output device the output of |
| device | which is receivable by the sense of smell. |
| tactile feedback device | A sensory output device the output of |
| | which is receivable by the sense of |
| | touch. |
| render | The process of converting an aspect of a |
| | simulated physical reality into a form |
| | compatible with a sensory output device |
| | of a given type. Said simulated physical |
| | reality may be represented by a |
| | Unchangeable-Event-List. Said |
| | conversion may also be further restricted |
| | by a set of sensory output device |
| | capabilities. A typical render operation |
| | may be the conversion of the view from a |
| | given position in given direction within a |
| | simulated physical reality or a |
| | Unchangeable-Event-List to a form |
| | suitable to a display device with a given |
| | set of capabilities, for example, 1080i |
| | HDTV. |
| render-instance- | A set of specifications, including |
| object | simulated physical reality or |
| | Unchangeable-Event-List spatial |
| | position, which comprise the definition |
| | of the conversion process of a render |
| | operation. Typically referred to as a |
| | camera when the render is for a display |
| | device and a microphone when the |
| | render is for a sound output device. |
| event tesseract | The representation of a virtual world |
| | history as a set of objects and a set of |
| | time ordered events associated with said |
| | objects. Such a representation is used to |
| | store the narrative content in a pre- |
| | rendered form. Also referred to as |
| | Unchangeable-Event-List. |
| virtual world | A simulated artificial universe defined by |
| | a set of 3D numeric descriptions and |
| | preferentially further augmented by |
| | other numeric descriptions which |
| | include, but are not limited to, one and |
| | two dimensional information, audio |
| | content, and other content which defines |
| | a simulated environment. |
| model object | A set of data representing a particular |
| | configuration of a discreet item for use |
| | in populating a virtual world. Said item is |
| | typically intended for rendering on one |
| | or more types of sensory output devices. |
| meta object | A set of data representing a particular |
| | configuration of a composite item for |
| | use in populating a virtual world. May |
| | include references to one or more model |
| | objects and one or more meta objects. |
| | Said item is typically intended for |
| | rendering on one or more types of |
| | sensory output devices. |
| instance object | An individual and unique discreet item |
| | which can exist in a virtual world. Also |
| | the set of data representing said item. |
| narrative content | A time sequenced list of events, or a |
| | form that can be interpreted that way. |
| | Narrative content typically is a story, |
| | even a very simple one, but can also be |
| | an advertising commercial and other |
| | forms of entertainment or forms of |
| | presenting information. |
| broadcast content | Narrative content in a form suitable for |
| | broadcast. |

Definition List 3

| Term | Definition |
|---|---|
| Unchangeable-Event- | A plurality of numeric descriptions of |
| List | simulated events. An example of such |
| | an Unchangeable-Event-List is a list of a |
| | plurality of Event-Descriptions. |
| Event-Description | A numeric description of a simulated |
| | event. An example of such an Event- |
| | Description is numeric association |
| | between a 3D-Element, an Element- |
| | Attribute, a time and a duration in which |
| | the association is made and maintained. |
| 3D-Element | A specific Encoded-Sensory-Description |
| | further described by a numeric |
| | representation for a 3D-Over-Time- |
| | Like-Space. Numeric representations for |
| | a 3D-Over-Time-Like-Space include but |
| | are not limited to: a four value list, three |
| | values for a location in 3D-space and |
| | one for a point in time; a four list of |
| | value ranges, three value ranges for a |
| | region of space and one value range for |
| | a point and duration in time, or some |
| | combination of these that reduces the |
| | number of values without compromising |
| | fidelity or accuracy. |
| Element-Attribute | A numeric encoding of characteristics |
| | which describe aspects of a 3D-Element. |
| | Such characteristics may include but are |
| | not limited to: location in 3D-Like- |
| | Space, mass, velocity, rate of change of |
| | velocity, animations, color, texture, |
| | series of textures to use, procedure rules |
| | for creating a surface patter, geometry, |
| | rules for creating a shape, magnetism, |
| | charge, hardness, reaction to impact, |
| | flavor, sound generation, roughness, and |
| | heat. |
| 3D-Like-Space | A representation that describes the |
| | characteristics of a 3 dimensional space, |
| | or a space approaching 3 dimensions. |
| | This includes but is not restricted to |
| | quantized values for 3D-Space, values |
| | for a partially 3D-Space where one or |
| | more dimensions is warped in non- |
| | uniform ways, or a substantially 3D- |
| | Space composed of a plurality of |
| | separate 2D planes. |
| 3D-Space | A three dimensional space. |
| Encoded-Sensory- | A numeric data set with encoded |
| Description | information representing at least one of |
| | the Human-Senses, such that said |
| | encoded information can be decoded |
| | and rendered to a sensory output device |
| | to induce a human sensory experience |
| | analog of said encoded form. For |
| | example sight can be encoded as a |
| | series of still images to be displayed on |
| | a display device. Sound can be encoded |
| | as waveforms to be reproduced by a |
| | sound output device. Touch may be |
| | encoded as pulses to be reproduced by |
| | force-feedback mechanisms. |
| 3D-Over-Time-Like- | A 3D-Like-Space-Model with an |
| Space | additional representation for time. The |
| | representation of time includes, but is |
| | not restricted to, quantized intervals (i.e. |
| | 1/30 of a second), range descriptions |
| | (from seconds 23 to 28), or as |
| | sequences of abstracted event |
| | descriptions associated with a time |
| | interval. |
| 3D-Like-Space-Model | A substantially three dimensional model, |
| | which may include but is not limited to: |
| | fully 3 dimensional models, two |
| | dimensional projections from 3 |
| | dimensional models, multi-layered 2 |
| | dimensional models, and models created |
| | from functions describing 3 valued |
| | space. |
| Human-Senses | The human senses consisting of sight, |
| | hearing, taste, smell, touch, |
| | thermoception, nociception, |
| | equilibrioception, and proprioception. |

What is claimed is:

1. A method of substantially automated production of content for a plurality of sensory output devices comprising:
a plurality of algorithms for generating a Unchangeable-Event-List encoding of simulated events;
an autonomous means of translating said Unchangeable-Event-List to an encoding suitable for input to a plurality of sensory output devices;
wherein said plurality of algorithms includes physical reality simulation engine algorithms for generating said Unchangeable-Event-List, and wherein said autonomous means of translating said Unchangeable-Event-List includes rendering controlled by the position and direction of one or more render-instance-objects, and wherein said rendering operates asynchronously to said physical reality simulation engine algorithms, and wherein said Unchangeable-Event-List is stored on a digital storage device, and wherein said substantially autonomous production is designed to produce continuous indefinitely long duration content, and wherein the majority of said plurality of sensory output devices are at remote locations from said Unchangeable-Event-List stored on said digital storage device.

2. A method of substantially automated broadcast content production involving minimal human input comprising the method of content production of claim 1 and where the production process consists of a plurality of stages, such that each stage is either:
an initial stage, which does not consume as input the output from another stage, and which produces output consumed as input by at least one other stage;
a dependent stage, which consumes as input the output produced by at least one other stage, and which produces output consumed as input by at least one other stage;
the final stage, the output of which is the final broadcast content;
and where there exists one and only one final stage, and where a stage may require human input to complete its production output.

3. A method of broadcast fictional content production comprising a production process designed to indefinitely produce said content at an average rate equal to or greater than said content presentation rate.

4. A method of automated determination of a component of said content produced using the method of claim 1 comprising the existing or predicted state of a characteristic of the physical environment of said remote location at some specified time and use of said state to determine said component.

5. The method of claim 4 wherein said component is the state of said characteristic of the content.

6. The method of claim 5 wherein said specified time is the time of reception of said content at said remote location.

7. The method of claim 5 wherein said specified time is the time of presentation of said content on said plurality of sensory output devices at said remote location.

8. The method of claim 5 wherein said characteristic is sunrise/sunset time.

9. The method of claim 5 wherein said characteristic is the position in the spring, summer, fall, and winter seasonal cycle.

10. The method of claim 5 wherein said characteristic is a meteorological condition.

11. The method of claim 5 wherein said characteristic is viewer position.

12. The method of claim 4 wherein said characteristic is the number of viewers.

13. The method of claim 12 wherein said specified time is the time of reception of said content at said remote location.

14. The method of claim 12 wherein said specified time is the time of presentation of said content on said plurality of sensory output devices at said remote location.

15. The method of claim 12 wherein said component is the time at which specific events appear in said content.

16. A method as described in claim 1 wherein a portion of said autonomous means of translating said Unchangeable-Event-List involves transmitting an encoded portion of said Unchangeable-Event-List is to a device located in close proximity to said sensory output devices at each said remote location, and where said device at each said remote location performs the majority of the rendering portion of said autonomous means of translating said Unchangeable-Event-List.

17. The method of claim 16 wherein said renderings are customized to the sensory output device types and sensory output device capabilities of each said sensory output device which will receive said renderings.

18. A method as described in claim 1 wherein said autonomous means of translating said Unchangeable-Event-List is influenced by a numeric data set representing audience preferences.

19. A method as described in claim 1 wherein said generated Unchangeable-Event-List or said autonomous means of translating said Unchangeable-Event-List is designed to influence the audience to prolong operation of said sensory output devices.

20. A method as described in claim 1 wherein for any one presentation of said content on said plurality of sensory output devices at said remote location, the majority of said generated Unchangeable-Event-List is not utilized by said autonomous means of translating said Unchangeable-Event-List.

21. A method as described in claim 1 wherein said rendering is performed during the presentation on said plurality of sensory output devices of said content.

22. A method of selling to a purchaser the use of, and the use of content produced by, the method of content production as described in claim 1 wherein said substantially automated production is substantially controlled by said purchaser in exchange for compensation from said purchaser for said use of, and the use of content produced by, said method of content production.

23. A method of selling advertising time in content produced using the production method as described in claim 1 wherein said autonomous means of translating said Unchangeable-Event-List includes additional content included from a purchaser in exchange for compensation from said purchaser for including said additional content.

24. A method of increasing revenue by increasing viewer interest of produced content using the production method as described in claim 1 wherein said plurality of algorithms includes use of a numeric data set containing information for a viewer or an audience to target said Unchangeable-Event-List to that specific viewer or audience.

25. A method of selling the right for a purchaser to control aspects of content produced using the production method as described in claim 1 wherein said autonomous means of translating said Unchangeable-Event-List includes a numeric data set describing said purchasers preferences for said aspects in exchange for compensation from said purchaser for said control of said aspects of said content.

26. A system for substantially automated production of content and transmission of said content to a plurality of remote sensory output devices comprising:
a first computational mechanism for performing the execution of a plurality of algorithms calculating the simulation of a physical reality which generates an Unchangeable-Event-List encoding of simulated events;
a digital storage device for storage of said Unchangeable-Event-List;
a second computational mechanism for performing a translation, under rendering control from one or more render-instance-objects by position and direction, and asynchronous to said simulation, to a suitable encoding for reception by a plurality of sensory output devices;
a mechanism for transmitting a portion of said Unchangeable-Event-List from said storage device to said second computational mechanism;
a mechanism for transmitting said suitable encoding to said plurality of remote sensory output devices.

27. The system of claim 26 wherein the majority of said plurality of sensory output devices are located at remote locations from said Unchangeable-Event-List stored on said digital storage device.

28. The system of claim 26 wherein said rendering is performed during the presentation on said plurality of sensory output devices of said content.
